(19) United States
(12) Patent Application Publication
(10) Pub. No.: US 2017/0052149 A1
(43) Pub. Date: Feb. 23, 2017

(54) ACOUSTIC EMISSION INDICATIONS OF DEFECTS FORMED DURING ELONGATED METAL MATERIALS MANUFACTURING PROCESSES

(71) Applicant: Andritz Sundwig GmbH, Hemer (DE)

(72) Inventors: Kari Aura, Tampere (FI); Hartmut HAASE, Hemer (DE)

(21) Appl. No.: 15/119,704

(22) PCT Filed: Feb. 16, 2015
(86) PCT No.: PCT/EP2015/053199

§ 371 Date: Aug. 17, 2016

(30) Foreign Application Priority Data
Feb. 17, 2014 (FI) 20145157

(51) Int. Cl. G01N 29/14; G01N 29/48

(52) U.S. Cl. CPC G01N 29/14; G01N 29/48; G01N 2291/0234; G01N 2291/0258

(57) ABSTRACT

A method of detection of defects in a manufacturing process of an elongated metallic material (1) which manufacturing process is accomplished by rolls (3, 6) which rolls (3, 6) reduce the cross section of the elongated metallic material (1) thinner and/or divert or guide the path of the elongated metallic material (1). The formation and/or existence of defects of the elongated metallic material (1) is detected by sensing acoustic emission transmitted by origination or advance of the defects and the detection is accomplished by at least one acoustic emission (AE) sensor (9) having direct or indirect contact with the elongated metallic material (1) which AE sensor (9) transduces the sensed acoustic emission to electric signals and the signals are received by an analyzing unit (21) which is capable of detecting the indication and reporting time coded indication and/or the indicative amplitude of the originated or advanced defects.

The invention relates to detection of defects and faults within manufacturing processes of elongated metal materials.

Manufacturing of elongated metal materials such as slabs, billets, strands strips, sheets or bars etc. typically starts so that molten metal is solidified to have a preformed cross section. The resulted preformed state may be a discontinuous billet or slab or the process may produce an endless slab, like a continuous casting process does. After the molten metal is solidified, it is typically subjected to forming the material mechanically to reduce the cross section of it. First forming of the solidified metal typically happens in a hot state when the material is soft and ductile and the cross section of it can be extensively changed.

In cold state the material has to be ductile enough to be able to keep its integrity during the following forming stages. Between cold forming stages, the material may be reheated to recrystallize the structure in order to make it possible to form the elongated material further. To maximize the production rate and to minimize the number of any forming stages, the deformation rate is adjusted to be close to the limits of ductility of the material. Typically the metal strip is cut into shorter pieces to make the handling and later processing possible. The mostly used process for reducing the cross section of the elongated metal material is forming between rolls i.e. rolling. Drawing may also be used when producing bar or tubular like forms in which the width and height of the formed cross section are quite equal. In cold rolling and especially in a drawing process a remarkable drawing force will create tensile stress and increase risks of initiating and advancing of cracks during the process. In a rolling process, compressive feeding force can be added by driven forming rolls.

As the thickness of a metal strip is reduced during rolling, the length of it is increased. The thinner the strip is, the less the width of the strip will increase. Especially in the cold rolling stages, edges of the strip are most prone to cracking as the metal sheet is not supported in the lateral direction. In any forming processes also for example impurities or local inhomogeneity of alloying elements can induce cracking. The greater the deformation rate is and the harder and less ductile the formed metal is, the more susceptible it is to cracking. The cracks will mostly be in the transverse direction of a strip if the crack is not caused by metallurgical reasons. If there will be later forming phases, the crack will grow bigger. If the strip is under tension during forming, the crack can grow through the cross section and the strip may be broken transversally. The breakage of the material will cause damage i.e. to the rolls and also the surrounding periphery may get damaged. This leads to a quite long downtime and replacement or repairs of the expensive tooling.

Another stage prone to cracking is in the solidification phase, especially when the metal is highly alloyed. Differently cooled areas may then cause overstressing of the material which has fragile alloying elements concentrated during the solidification phase to the middle section of the material. Impurities can also concentrate equally and induce cracking in any later forming stage. Such cracking will often occur in the planar direction. Ragged surface and also internal defects like voids may also be formed during the casting process. Any cracking or other defects should be detected as early as possible to avoid further processing of the damaged area of the material and to avoid the growth of the defect and further increase of costs related to quality and incurred by repairing or scrapping processed material.

Non-destructing testing (NDT) such as for example using ultrasonic sensors, which receive signals or echoes which ultrasonic transmitters have emitted, have been tried for detecting cracking online during production of elongated materials and offline between process stages. During hot forming and directly after continuous casting, the high temperature creates the main problem when using ultrasonic testing which need a good contact to the metal to be able to transmit and receive the signals. Especially during cold forming the processing speed of the material excessively hinders getting the contacts in a stable state to deliver the sound waves and the speed also limits the time needed to detect the fast moving faults. Ultrasonic NDT methods are good at detecting faults that have a substantial planar component when the thickness of the strip is several millimeters. The thinner the strip is such as in cold forming stages, the more unreliable the method is for detecting typical defects that are transverse to the plane of the strip and formed especially when the feeding force is a drawing force. Some examples of the ultrasonic NDT of rolling processes are presented in publications U.S. Pat. No. 7,987,719 and U.S. Pat. No. 4,160,387.

Acoustic emission (AE) is widely used for monitoring the condition of highly stressed components such as pressure vessels and rotating objects. The method can detect abnormalities such as excess friction, damaged bearings or gears, unwanted contacts to other components and crack formation. An example of using AE in monitoring of faults and defects of rotary machinery is disclosed in publication U.S. Pat. No. 4,669,315.

### SUMMARY

The purpose of the invention is to reliably detect defects initiated and advanced during manufacturing processes of elongated metal materials. Preferably the defects are detected in as early a stage as possible and the position of the defect will also be located for earliest possible corrective actions with least extent. The purpose is achieved such that the method and/or apparatus defined in the preamble of the independent claims are implemented as defined in the characterizing part of the claims. Preferred embodiments of the invention may correspond to the dependent claims.

The invention is based on detection of acoustic emission, which is emitted during crack formation as a crack is originated or advanced when the elongated material is solidified or deformed. Also other surface or internal defects and process faults may cause distinguishable abnormal acoustic emission during a manufacturing process. The type of defect can mostly be recognized by the characteristic properties of the acoustic emission and usually it is useful to know that in a located place some kind of defect may exist. At least one acoustic emission (AE) sensor is used to receive the acoustic emission from the originating or advancing defect and to transduce it to indicative electric signals. Filtering, frequency analysis and other digital signal analyzing and processing means may be used to separate background noise generated by bearings, other process conditions or devices for detecting the indications of the originating or advancing defects.

A defect of an elongated metal material will usually be in form of a crack. Other material defects such as grooves, notches or other surface defects as well as internal defects such as voids may also be detected especially when the material is deformed. Different types of defects usually give different indications so that the frequency is in a certain range and over a threshold amplitude or the duration of an occasional signal may have a characterizing and/or quantitative indication. For detecting certain types of defects, an AE sensor tuned to be sensitive to a certain narrow frequency area may be used to filter out disturbing signals. Mostly the monitored processes are recurrent and therefore the different indications can be examined and learned and also information about the extent of the defect can be calculated based on the frequency, amplitude and/or duration of the indicating signal.

The AE sensor needs a path with good contact to the monitored material to function. The generated acoustic emission from the defect travels well quite a long way through metals and liquids to the sensor. Therefore the AE sensor does not need to be very close to the originating or advancing defect, but the closer and the better the contact is the better is the selectivity to get the indication from the defect. Also any boundaries between participative parts should be avoided.

If only one forming stage is in the production line, only one AE sensor is needed to indicate and locate accurately a defect in the longitudinal direction as the defect will originate or advance in the forming position. If the corrective action is to split transversely the material in that point to remove the defect, that information is enough to direct the cutting operation to the calculated or metered lengthwise position. Also, if the defect will be analyzed by other NDT methods before correcting operations, the lengthwise information is mostly adequate for fast finding of the defect. Transversely cutting of cold formed coiled strip is often not the best corrective action as it leads to more discontinuities in the production processes. Usually longitudinal trimming of the coiled strip is a preferred and more cost effective correcting action if there is a crack of limited length at an edge of a strip.

Preferably indications of the indicated defects and the indicated sizes of them are stored so that the trend of indicated defects can be used to adjust the process parameters for preventing origination of defects. Excessive existence of defects may also be caused by inadequate pretreatment or metallurgical properties of the processed metal being out of tolerance. Halting a process or alarming an operator of it may also be needed to perform, if an oversized defect is determined by calculation or an indicative amplitude exceeds a predetermined indicative threshold value of an excessive defect.

A monitoring system for detecting and reporting defects comprises of at least one AE sensor 9 which is in an acoustic path contact to a processed elongated material 1 and between different manufacturing stages and lines may be used to further process and report the indications and perform corrective actions.

If the need is to locate the defect in the lateral direction of a strip, the task can be solved by positioning at least a pair of AE sensors to different transverse distances from an edge of the strip. The longitudinal position should preferably be substantially equal. Then there will be difference in the receiving time and typically in the amplitude of the indication of the defect. If the strip to be rolled is thin, the location of the defect is presumably on one of the two edges of the strip. Then comparing timing of the indications received by the pair of AE sensors will lead to a conclusion on which side the defect is located. The conclusion based on the timing is not relevant if the time difference does not correspond to the timing difference of acoustic paths from an edge of the strip to the AE sensors. The stronger and/or the sooner indication will be at the side of the defect. Even if the amplitudes are substantially at the same or slightly conflicting level, the earlier receiving time is a stronger indication of the side of the defect. If the strength of the amplitude and the receiving time are in a stronger conflict against these principles, the indications are supposed to represent two different defects at different sides of the sheet. By knowing the side of the defect and the level of the amplitudes, the monitoring system can calculate a report on which side of ?? the strip should be trimmed, how much and at which longitudinal location. If the whole length of a defected strip will be trimmed, at least from one damaged side, the information of the longitudinal position of the defect is irrelevant. If there is a need to find and examine the defect more accurately for comparing it to the calculated extent of it, the longitudinal location is still needed.

By having the first indication about a crack as soon as possible, the loss of material in trimming will be less than if the sheet is rolled thinner in the next production line or next pass in the same line because normally the crack will grow. If the time values of the indications do not differ as much as they should according to the time differences in acoustic paths, the defect may be within the inner area of the sheet and the location should be inspected or be cut away and scrapped. In this case there might also be two separate defects which have given indications.

Acoustic emission may not travel well through a forming process as the forming itself creates acoustic emission and the waves may be otherwise damped. If there is more than one rolling stage in the forming process line, each stage may be needed to be monitored separately as the indication may not reach the AE sensors through another rolling stage. There should be at least one AE sensing point for two forming stages. An AE sensor in contact with the elongated metal material between two forming stages can detect indication of a defect from both directions. If a crack is formed in the first stage, an indication of the defect will happen also at the second stage as the crack will eventually grow then. If there are two indications of a defect which have equal time difference that is the time difference between the two stages there supposedly is only one defect which has given two indications. If there will be only one indication, the crack has initiated at the second stage.

If the size of the defect needs to be evaluated, all forming stages and their corresponding AE sensors and analyzing units should be calibrated to correspond to the size of the indication. By examining the detected defects, an equation between the detected indicative amplitude and the size of the defect can be created. The equation will be affected by different combinations of process parameters and processed materials.

Continuous casting is typically a vertical process. After solidification of at least the surfaces of the metal, the process is turned to be a horizontal forming process as the material is in a soft state. The turn is made by rolls that typically do not deform the metal thinner but they just direct it to move horizontally. During solidification and at later cooling and hot deforming phases with especially heavily alloyed or otherwise less ductile alloys may occur hot cracking or deformation cracking in most intensive hot deforming stages. A moving hot rough surface in the solidification stage and hot forming stages is not a good contact surface for an AE sensor as the contact itself will create noise. As the material is hot, the AE sensors cannot contact directly the processed material. Also there will typically be slag on the surfaces of especially steels or the surface is too rough to have direct and reliable contact. Preferably the AE sensors are connected indirectly via rolls or their supporting structure or rollers to suppress conduction of heat. The sensors may be of a type which resists elevated temperatures.

Locating of an originating crack or other defect in the solidification phase is not as accurate as in the forming stages as the point where the cracking will occur can be in a longer area. As the crack is later advanced in a deforming stage, the advancing crack or other defect can be more accurately positioned. Then the locating procedure is quite similar to the prior described. As the continuous casting process and the hot forming stages after solidification are continuous processes, it is difficult to make corrective actions during the process before the metal is cut into shorter pieces. If the defects are only local and occasional, the process needs not be cancelled but maybe it needs to be adjusted to eliminate the formation of defects. When accomplishing corrective actions to continuously casted billets or slabs, the location information of the defects is critical in finding them fast. At the same time of localizing the defect, the originating stage of it can be detected too. That information helps to analyze which corrective actions are needed to adjust the parameters of the defect-prone process or stage in the often long continuous casting process line with several successive forming stages.

AE sensors can be arrangedin their detecting positions in many ways. The simplest solution is to attach the AE sensor to the supporting structure or frame of the processing device or component which is in contact with the processed material. An acoustic emission path to the AE sensor may be via a forming roll, supporting roll or other roll or roller. In most solutions this is an adequate way. The elongated metal material has a good contact to the roll or roller and the acoustic path will go through it and its bearings to the bearing housing and the path continues also to the other support structure of the roll such as the frame of the device. Acoustic emission travels very fast and it does not damp aggressively in metals. Any junction or boundary that the acoustic emission needs to travel through can dampen it and can cause echoing. Also any other moving elements such as the supporting rolls and the bearings will create background acoustic emission of different levels and frequencies. Therefore the acoustic path from the originating or advancing crack to the AE sensor should be as short as possible for maximum resolution of indications.

A deforming metal will create continuous acoustic emission due to dislocations and other ductile forms of deformation. This continuous acoustic emission needs to be filtered out to extract data concerning the occasional short high amplitude acoustic emission bursts created by defects.

The surface of a processed strip is usually smooth and cool enough in cold forming stages for having a reliable direct contact to the strip. The AE sensor can be most directly contacted to the moving surface via a rolling means or via a sliding means. Both types of direct contacts may be lubricated by oil or other liquid to get a better signal path and on sliding contact to dampen or eliminate acoustic emission originating from friction. A liquid will conduct the acoustic emission well to the AE sensor. The directly contacted AE sensor can easily be isolated from the background signals generated by surrounding machinery and mainly acoustic emission from the processed target is received.

Due to temperature, surface properties and lubrication problems, a rolling contact AE sensor is a preferable direct contact solution for monitoring of hot processes. Using contacting intermediate material that is liquid at elevated temperatures may cause more trouble, such as contamination, than give advantage in the sensing task. When a direct contact to the metal material is used, an AE sensor may be isolated and/or cooled to prevent overheating.

When the AE sensors are attached to the supporting structure of a rolling machine, the same collected data can be filtered and examined also by other means for monitoring the whole process to find out also abnormalities or unwanted functions of the attached components or process parameters. For example worn out bearings and gears, lack of lubrication of the process or moving parts, defected surfaces of the rolls, loose parts, dirt like burr stuck on moving surfaces or fractured components can be detected and reported by the same monitoring system.

### LIST OF DRAWINGS

In the accompanying drawings:

FIG. 1 is a side view illustrating a continuous casting process,

FIG. 2 illustrates as a principle a side view of two successive hot or cold forming rolling stages,

FIG. 3 illustrates an attachment of AE sensors to bearing housings on both ends of a roll,

FIG. 4 illustrates an AE sensor which has a rolling contact to a metal strip,

FIG. 5 illustrates three different ways of arranging an AE sensor 9 to have a sliding contact to a strip,

FIG. 6 illustrates signals received from an originating crack type of defect and an advance of the crack and

FIG. 7 illustrates signals received by a pair of AE sensors from a same forming stage.

### DETAILED DESCRIPTION

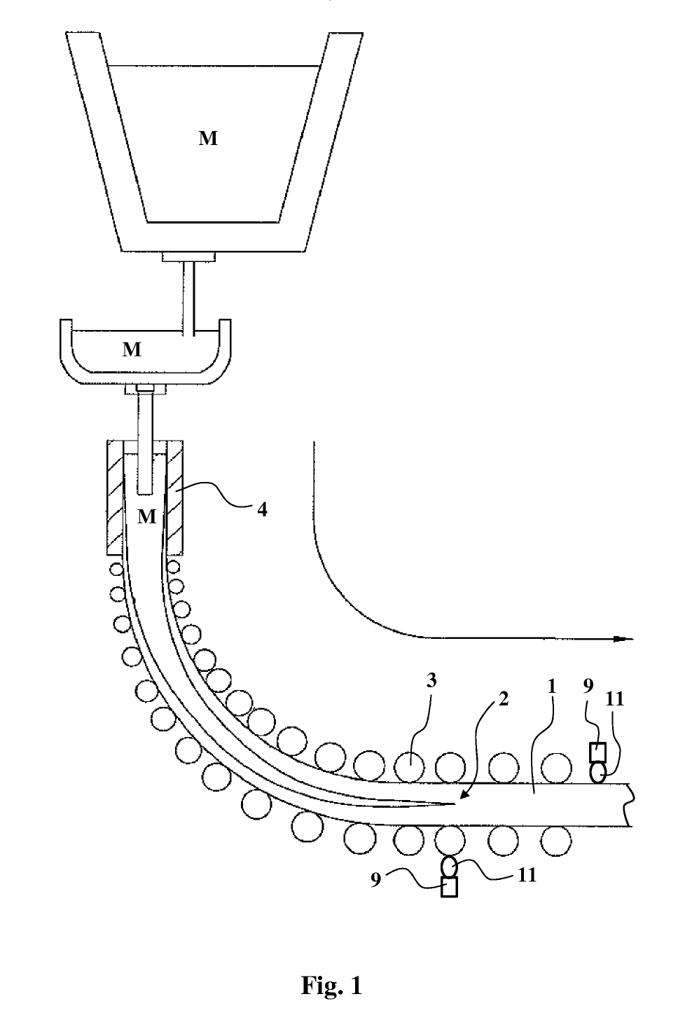

FIG. 1 is a side view illustrating a continuous casting process in which molten metal M is supplied to a mold 4, wherein molten metal will be solidified in this phase to form a shell of a strand 1. The same reference number 1 is later used to represent every later form of the elongated metallic material 1. The solidification inside the strip 1 will continue due to continued cooling and supporting rolls 3 draw and direct a vertical material flow to horizontal movement. In a solidification point 2 all molten metal in the middle of the strip 1 will be solidified. An optimum positioning of an acoustic emission (AE) sensor 9 for detecting the solidification cracks will be after the mould 4 and not much after the solidification point 2. To avoid problems with the hot environment, the AE sensor 9 is contacted to the strip 1 via a roller 11 contacting to a support roller 3. The AE sensor 9 may also be attached to a supporting structure of the support roller 3. To receive strongest signal, the AE sensor 9 should more directly contact the strand 1 via a roller 11.

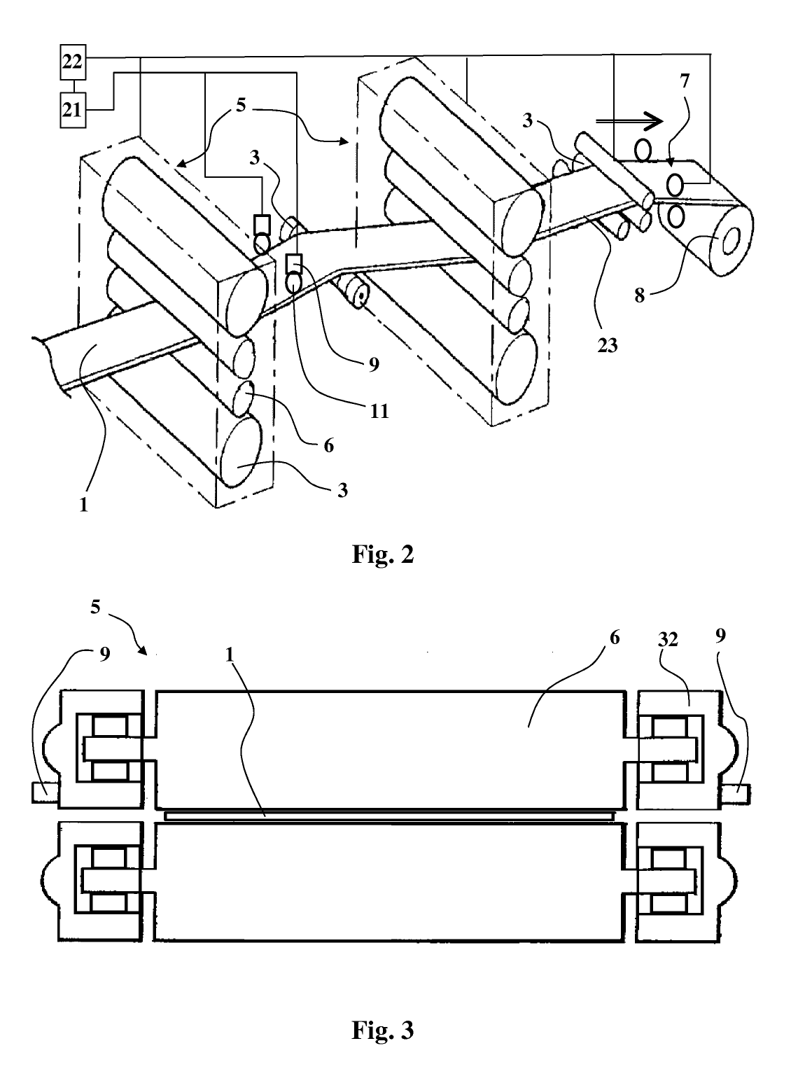

After the casted metal is solidified to a strand 1, it is either hot formed thinner by one or several rolling stages or it is cut into defined material lengths. This feed stock can be further processed in hot or cold forming processes into sheets 1 or coils 8 (FIG. 2). Typically the cutting length of the processed material 1 depends on the next manufacturing or process step.

FIG. 2 illustrates a principle side view of two successive hot or cold forming rolling stages 5. Elongated metal material 1 is supplied in a strip form to a forming stage 5. In the stage 5 forming rolls will squeeze the sheet 1 thinner and more elongated. A work roll 6 of forming stage 5 may be supported by one or several support rolls 3. The strip 1 may be supported by opposing support rolls 3 and other individual support rolls 3. After the forming stages 5 the strip 1 is coiled to a coil 8. A transverse cutting stage or a longitudinal cutting stage 7 for trimming the edges of the strip 1 may exist before the winding phase. The trimming stage 7 may also be performed by separate units or other production lines or in any other production stages.

A pair of AE sensors 9 are arranged to be in contact with the strip 1 via a roller 11 after the earlier forming stage 5 to monitor the forming process. Any other forming stage 5 may be equally monitored. A sliding contact could be used instead of the rolling contact. The two AE sensors 9 are located close to the both edges of the strip 1. The closer the AE sensors 9 are to the edges and work roll 6 of the forming stage 5, the bigger is the time difference and difference in amplitude between AE signals of the two AE sensors 9, which signals are indications of a single defect originated or advanced at an edge of the strip under the forming stage 5. The time differences in an acoustic path from one edge to the AE sensors of different sides can be calculated or determined for further use from time coded indicative signals of earlier recorded and confirmed cracks.

Typically the same defect that has existed in the earlier forming stage will advance in the successive forming stage 5. That emission from the advance of the defect may also be received by the same AE sensors 9. Due to different dampening properties equation for calculating the size of the defect should be adapted to fit to the changed circumstantial factors. Also due to dampening and tiny time difference due to long distances, locating the side of the originating defect in the successive forming stage 5 will be less reliable or impossible.

Due to applied strip 1 tension, the defect more typically originates and advances on the last moments of the forming stage 5 and it can still advance after passing the work roll 6. Therefore the AE sensor 9 should be positioned in the direction of movement of the strip 1 after the forming stage 5 which is monitored by the AE sensor 9.

FIG. 3 illustrates an attachment of two AE sensors 9 to bearing housings 32 on both ends of a work roll 6. In view of maximizing the time difference of received signals from a defect located on an edge of the strip 1, the arrangement can be the optimal solution. In case it is difficult to arrange a directly contacting AE sensor 9 on the strip 1 very close to the work roll 6, an AE sensor may be attached as close as possible to any other supporting structure of a support roll 3 which is in direct contact with the strip 1 or work roll 6. It is also possible to place the AE sensor within a support roll 3 or a work roll 6. In that case, the signals are transmitted wirelessly or by a rotating connector to an analyzing unit 21.

An advantage of arranging an AE sensor to the bearing housings or other support structure of the work roll 6 or to the frame of the process machine is that from the same signal data other abnormal process conditions and faults in the components can be detected and monitored simultaneously. Since the characterizing frequencies, durations and/or levels of other acoustic emissions of faults are known by research or other sources, the same signals can be filtered and/or otherwise analyzed. Then any abnormalities are detected and reported or at least a report is created of a need to analyze the process and/or devices more deeply before any product quality issues or mechanical faults will happen.

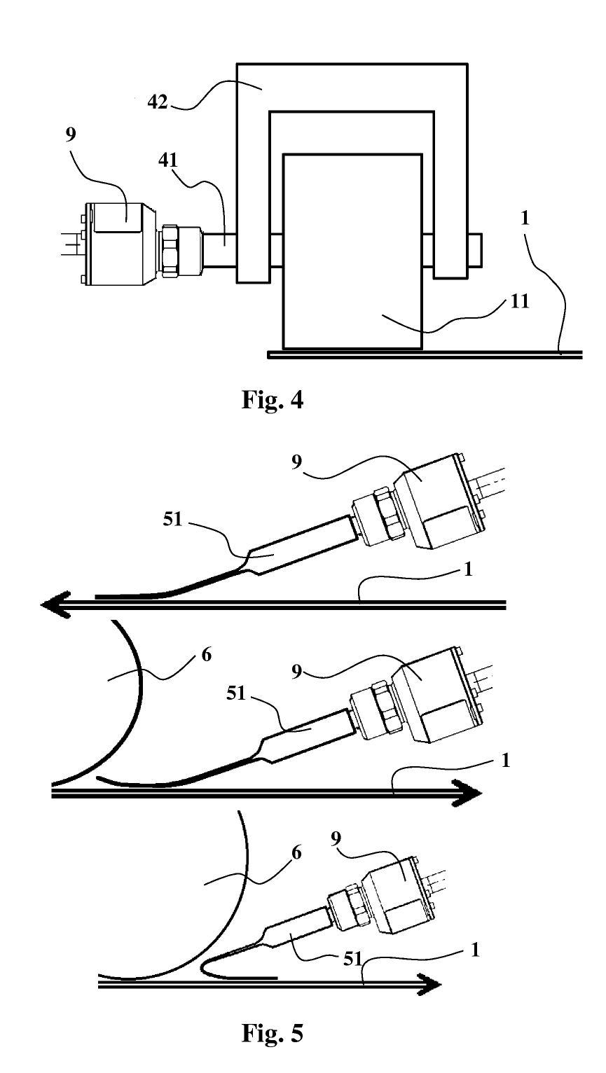

FIG. 4 illustrates an AE sensor 9 which has a rolling contact to a strip 1. A roller 11 is in direct contact with the strip 1. In this case when the AE sensors 9 are arranged as pairs, it will be positioned close to the edge of the strip 1. If the sensor is used independently, it should contact to the middle area of the strip 1. The roller 11 may also contact any of the forming rolls 6 or any of the support rolls 3 like in FIG. 1 and then the contact with the processed metal 1 is indirect. An AE sensor 9 is attached preferably to the shaft 41 of the roller 11 to get as short and direct a path as possible. If there are low noise bearings between the shaft 41 and the roller 11, the AE sensor can be connected to analyzing unit 21 via fixed connections. If the bearings of the shaft 41 are between the frame 42 of the device for getting a better path for the acoustic emission, the AE sensor needs to have a rotary connector or wireless communication to connect it to the analyzing unit 21. The contact from the shaft 41 to the support frame 43 or to the bearings between the shaft 41 and the frame 42 should be isolated to dampen external noise. Also the frame 42 should preferably be isolated from its periphery. The AE sensor 9 can also be attached to the frame 42 instead of the shaft 41, but then there will be more boundaries in the path. The surface of the roller 11 may be coated with a softer but still acoustic emission conducting tire or be lubricated to prevent disturbing background noise from a metallic contact. Especially at the speeds of strips used in the cold rolling stages, the diameter of the roller 1 should be adequate to prevent high frequency noise caused by a high rotating speed. The diameter of the roller 11 should be at least 100 mm. When contacting high temperature objects, a larger diameter leads to less heat conducted from the object.

FIG. 5 illustrates three different ways of arranging an AE sensor 9 to have a sliding contact to a strip 1. A waveguide 51 with a flat end with a width of at least 10 mm is attached to the AE sensor 9. The flat end is in contact with the strip 1. The contact is preferably arranged via a lubricating fluid film which will prevent frictional noise but will very well lead the acoustic emission to the waveguide 51. The oil used in rolling processes and left on the surface of the strip 1 may be an adequate amount of fluid. Additional fluid may be fed between the strip 1 and the waveguide 51. The waveguide 51 has an area which is slightly inclined upwards at the incoming side for collecting and maintaining the fluid film. The AE sensor 9 or the waveguide 51 will be connected to a frame of the monitored process device. This connection should be isolated to prevent external noise. The uppermost design needs some amount of space in the incoming side. The two lower designs are preferable if the sensing position should be located as close to the work roll 6 as possible to maximize the time difference between indications from paired AE sensors 9 and to minimize the dampening of the acoustic emission.

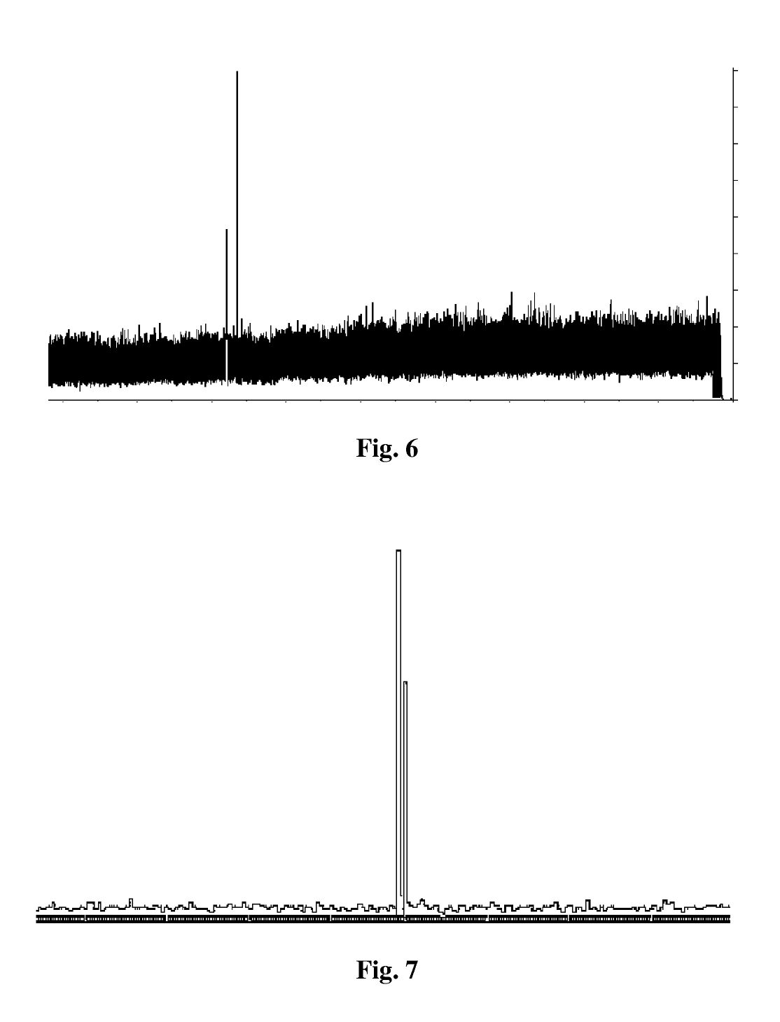

FIG. 6 illustrates signals received from an originating crack type of defect and an advance of the crack. The white signal level represents acoustic emission signals by a first AE sensor 9 from an earlier cold forming stage 5 during a pass of one coil 8 of strip 1 and the black signal represent AE signals received by another AE sensor 9 from a later cold forming stage 5 of the same production line and during a pass of the same coil 8. Both the time values of signals on horizontal scale and level of signals on vertical scale are equal. Left black recolored peak indicates an originated crack formed in the earlier forming stage 5. The height of the peak is in relation with the extent or length of the crack. A formula between the length of the crack and the level of the peak value can be empirically defined. Right peak represents an advance of the same crack if the time difference equals to the time difference between the two forming stages 5. The same analysis can be made even if there is only one AE sensor between the two successive forming stages 5 and the time difference of the peak values equals to the time difference between the processes. For determining the actual crack extent or length, it is needed to get the peak values from all of the forming stages 5 which the crack has passed as the indication can represent only the extent of advance of a crack in the forming stage, not the overall length of it.

A threshold value may be defined for an excess size of a determined crack which can cause breakage of the strip 1 and wider damage to process devices. If an excess size of a crack is determined and reported by analyzing unit 21 to process control 22, the process control can halt the production line to avoid potential damages. The analyzing unit may only report the level and the time code of the peak values and/or durations of the indicated or suspected cracks and the process control may be programmed to analyze and calculate the extent of the cracks and the overall extent or length of the advanced cracks.

FIG. 7 illustrates filtered signals received by a pair of AE sensors 9 from a same forming stage 5. As a crack is originated or advanced, the emitted acoustic emission is received by a pair of AE sensors which are on opposite sides of the centerline of the monitored strip 1. The indication of the crack is clearly expressed and the time difference of the received indications corresponds to the time difference between the longer and shorter paths to the otherwise similarly arranged pair of AE sensors. The AE sensor 9 positioned closer to the defect will receive the prior and higher peak signal and the further positioned AE sensor should receive the more dampened and later signal.

If the time difference between these indications corresponds to the time difference between the paths from a side of a strip 1 to the pair of AE sensors it can be reported to the process control 22 that a crack occurred to the side on which the AE sensor received the acoustic emission first.

If a pair of AE sensors 9 are in successive positions in the longitudinal direction of the process, the corresponding analysis can report at least approximately the location of the defect. This kind of arrangement can be used for example for locating the position of a defect in a continuous casting process or in the successive hot forming processes. If the time difference is less than the time difference between the advance of the elongated metal material 1 in the process between the positions of the AE sensors 9, the location can be defined quite accurately. If the time difference is equal, there is only one defect before the earlier AE sensor 9 or after the later AE sensor 9. As the AE sensor 9 which receives first the indication is closer, it can be determined which one of the two situations is correct. If the time difference is longer than the time difference between the positions, there should be two separate defects for which only approximate locations can be reported. If the determination of the location is only approximate, other NDT methods are needed to find the exact place of the defect from the reported approximated location.

The monitoring system according to an example of FIG. 2 comprises at least one AE sensor 9 which is in an acoustic path contact to a processed elongated material 1 and an analyzing unit 21. Plenty of hardware and software that can readily be used to monitor different objects are offered for example by Vallen Systeme GmbH. An AE sensor 9 is tuned to receive acoustic emission of those frequencies which will indicate the monitored types of defects. An AE sensor 9 will transduce the amplitude level of received emission to an electric signal of a corresponding voltage level which is transmitted to an analyzing unit 21 which is a part of the monitoring system. As an AE sensor 9 is most sensitive to certain frequencies, those emitted frequencies will be transduced to a higher voltage level than frequencies which are farther from the tuned resonance frequency.

For example a Vallen VS-150-M sensor is tuned to 150 KHz and will receive frequencies between 50 and 500 kHz. This type of AE sensor 9 will itself filter out most of operational noises and can give selective indications from crack formations in cold processing of carbon steels. Different metals and metal alloys may need differently tuned or wideband AE sensors 9 for indications of certain defects. Also different types of defects and faults, temperatures, drawing conditions thicknesses and other process parameters may lead to using an AE sensor 9 of certain tuning characteristics. A person skilled in the art can use a frequency analyzer or a set of different sensors to find the best indicative characteristics.

An analyzing unit 21 will log and time code the signals received from connected AE sensors 9. The analyzing unit 21 can filter out the general background noise so that indications from defects and the amplitudes of them will be clear. The analyzing unit 21 may report to a process controller 22 time codes and amplitudes of indications which exceed a predetermined indicative threshold value. An indication may be categorized and reported to represent a suspected defect if for a suspected defect is predetermined a threshold value which is smaller than the threshold value which indicates a detected defect. The analyzing unit 21 or the process controller 22 may deliver the report to the operator by for example visual report on a monitor. An audible alert may also be generated as an indication of a defect or a suspected defect. Preferably both the operator and the process controller 22 will receive a report.

The analyzing unit 21 may be programmed to analyze a location of a defect by comparing indications of defects from two or more AE sensors. For example it can be programmed to follow the earlier described methods to report on which side the defect is or if there are two independent defects. Built-in features for locating indicated defects are also commercially available in for example Vallen AMSY-6 software. The analyzing unit 21 may be an independent device based on a PC with a multichannel PCI-card or the analyzing unit 21 may even be integrated into a process controller 22. Also modern AE-sensors 9 with integrated analyzing units 21 can be used, these sensors have a capacity to process AE-signals and send individual analyzing results with accurate time code to the process controller 22 or other analyzing unit 21 for further processing and reporting.

The process controller 22 controls the process parameters and operations of connected production stages of a production line. It will also receive and keep up information about the longitudinal position and processing speed of the processed elongated material 1. The position information may be obtained for example from a speed and distance metering roller or from a support roll 3. As the speed and longitudinal position of the processed material, positions of the AE sensors 9, and the time codes of indicated defects are known, the longitudinal location can be quite accurately calculated. The process controller 22 may be programmed to perform spraying a color or other visual marking of the elongated metal material at the calculated location of the defect to speed up finding the defect manually.

The analyzing unit 21 or process controller may be programmed to calculate an estimated size of a detected defect. This information can be transmitted and reported to an operator of a trimming stage 7. In FIG. 2, the trimming stage 7 is on the end of a rolling line, but it can be a standalone device or at the beginning of another or same production line. The estimated size can be used to optimize the trimmed width of a defected side of a strip 1. If the process controller 22 is able to adjust the settings of the trimming stage 7, it may even automatically perform the set up of a trimming stage. If the estimated or inspected size of a defect is over a certain predetermined level, the reported location information is used to position the strip 1 into a cutting device to cut transversely off the defected position.

The process controller 22 may log and create a report of all of the indicated defects. This log can be used to determine if there is a need to adjust parameters of the controlled processes. If a certain amount of indications of defects is accumulated within a predetermined time interval, the operator can be alarmed to consider modifying the process parameters. Also if an amplitude or calculated size of an indicated individual defect will be over a predetermined threshold level, the process controller 22 may be programmed to halt the production line to avoid a potential breakage of the processed elongated material 1 and to avert wider damages.

1-16. (canceled)

17. A method of detecting defects in a manufacturing process of an elongated metallic material, the method comprising:
using rolls on the elongated metallic material to reduce the cross section of the elongated metallic material and/or divert or guide a path of the elongated metallic material;
detecting a formation and/or existence of a defect of the elongated metallic material by sensing an acoustic emission transmitted by origination or advance of the defect, wherein the detection is performed using acoustic emission sensors each having direct or indirect contact with the elongated metallic material, and transducing sensed acoustic emission to signals, and the signals are received by an analyzing unit which creates an indication of the defect if a predetermined threshold value of the signal is exceeded, and the analyzing unit creates a time coded report of the indication and/or of the indicative amplitude of the originated or advanced defect and wherein a pair of the acoustic emission sensors are at a substantially same position with respect to a longitudinal direction of the elongated metallic material and the acoustic emission sensors of the pair are located at opposite sides of a centerline of the elongated metallic material and wherein, in response to both of the pair of the acoustic emission sensors, generating signals within a certain time difference, a defect is reported to be proximate an edge of the metallic material corresponding to the one of the acoustic emission sensor of the pair which generated the signal corresponding to the earliest of the time coded reports and wherein the certain time difference equals a time difference between acoustic paths from said edge to each of the pair of acoustic emission sensors.

18. The method according to claim 17, wherein the contact of the acoustic emission sensors with the elongated metallic material is arranged via a roll or roller which is in direct or indirect contact to the elongated metallic material.

19. The method according to claim 17, wherein a direct contact of the acoustic emission sensors with the elongated metallic material is arranged by a sliding contact relationship between the acoustic emission sensor and the elongated metallic material.

20. The method according to claim 17, wherein the contact between the acoustic sensors with the elongated metallic material is a roll which extends to both sides of the elongated metallic material and said pair of acoustic emission sensors are connected to different ends of the roll or to support structures of the roll on different sides of the roll.

21. The method according to claim 17, wherein the time coded indication of an indicated defect is used to determine a longitudinal location of the originated or advanced defect on the elongated metallic material.

22. The method according to claim 21, wherein the time coded indication of the indicated defect is reported by the analyzing unit to be an advanced defect if an earlier indicated defect has a substantially same determined location as a later detected defect.

23. The method according to claim 17, wherein a size of the indicated defect is calculated from the amplitude and/or duration of the received signal.

24. The method according to claim 23, wherein the size of the reported advanced defect is calculated from the amplitudes and/or durations of at least two successive indicative signals received from the same defect.

25. The method according to claim 17, wherein a in response to a first of two signals indicating an indicated defect is substantially weaker than a later of the received signals, a report is generated that the later signal represents a second defect.

26. The method according to claim 23, further comprising generating a report about the calculated size of the defect and the edge where the defect is located is delivered by the analyzing unit to an operator or process controller of a trimming stage.

27. The method according to claim 17, wherein an acoustic emission from a defect originated or advanced during a solidification phase of a continuous casting process of the elongated metallic material is received by at the acoustic emission sensors attached to a support roll or its supporting components or to a roller.

28. The method according to claim 17 wherein the time coded reports of indicated defects concerning a certain process stage are stored in the analyzing unit or a process controller and an amount of the indicated defects is determined based on an accumulation of the time coded reports and if the amount of the indicated defects during a predetermined time interval exceeds a predetermined threshold value, an alarm is generated and reported by the analyzing unit or the process controller.

29. The method according to claim 17, wherein the acoustic emission sensors are positioned along a direction of movement of the elongated metallic material and downstream in the direction of movement of a forming stage which is monitored by the acoustic emission sensors.

30. The method according to claim 18, wherein the acoustic emissions received, by at least one of the acoustic emission sensors connected to an end of a work roll or to a support structure of the work roll, is used to detect faults in conditions and/or in a condition of components of a forming stage.

31. A method to detect defects in a metallic material comprising:
moving the metallic material with rollers along a direction of movement;
positioning a pair of acoustic emission sensors along a line perpendicular to the direction of movement and on opposite sides of a centerline of the metallic material, wherein the centerline is parallel to the direction of movement;
sensing acoustic emissions from the metallic material with the pair of acoustic emission sensors;
analyzing signals generated by each of the acoustic emission sensors to generate information on a time of receipt of the acoustic emission and a magnitude of the acoustic emission;
detecting a defect in the metallic material if the magnitude of the acoustic emission exceeds a threshold magnitude and associating the defect with each for each acoustic emission having a magnitude greater than the threshold and a timing within a certain period; and
generating a report identifying the defect and indicating that the defect is the one of the sides of the metallic material where the one of the pair of emission sensor is located that generated the signal having the earliest time of receipt.

32. The method of claim 31 further comprising determining a position along the direction of movement of the defect on the metallic material based on information indicating which section of the metallic material was near the acoustic sensors at the earliest time of receipt of the signal.

33. The method of claim 31 wherein the certain period corresponds to a time an acoustic emission travels from one edge of the metallic material to an opposite edge of the metallic material.
